(19) United States
(12) Patent Application Publication
(10) Pub. No.: US 2025/0144791 A1
(43) Pub. Date: May 8, 2025

(54) Reduction of Inverse Kinematic Calculation Time

(71) Applicant: The Boeing Company, Arlington, VA (US)

(72) Inventors: William Ko, Melbourne (AU); Jason John Cochrane, Tecoma (AU)

(21) Appl. No.: 18/500,521

(22) Filed: Nov. 2, 2023

(51) Int. Cl. B25J 9/16

(52) U.S. Cl. CPC B25J 9/1605; B25J 9/1653; B25J 9/1664

(57) ABSTRACT

Methods of reducing calculation time for inverse kinematics for a robotic arm are presented. An analytical solver is used based on design values for a robot type to generate an analytical solution of joint parameters to achieve a desired location of a tool center point of the robot type, wherein the robotic arm has the robot type. The analytical solution of joint parameters is provided as a seed value to a numerical solver for the robotic arm of the robot type. A numerical solution is determined using the numerical solver and the seed value, the numerical solution comprising joint parameters for the robotic arm to achieve the desired location of a tool center point of the robotic arm.

### BACKGROUND INFORMATION

### 1. Field

The present disclosure relates generally to inverse kinematics and more specifically to reducing calculation time for inverse kinematics for a robotic arm.

### 2. Background

Robot arm motion planning uses the calculation of inverse kinematics. For meaningful usage, calculations should be fast enough to allow real-time planning. However, each robot arm has its own set of as-manufactured length values for its respective components that influence accuracy of calculations. Inverse kinematic solving with calibrated parameters with as-manufactured values can be orders of magnitude slower than available analytical solvers.

Therefore, it would be desirable to have a method and apparatus that takes into account at least some of the issues discussed above, as well as other possible issues. For example, it would be desirable to provide inverse kinematic solving with a reduced time but a desired accuracy.

### SUMMARY

An embodiment of the present disclosure provides a method of reducing calculation time for inverse kinematics for a robotic arm. An analytical solver based on design values for a robot type is used to generate an analytical solution of joint parameters to achieve a desired location of a tool center point of the robot type. The robotic arm has the robot type. The analytical solution of joint parameters is provided as a seed value to a numerical solver for the robotic arm of the robot type. A numerical solution is determined using the numerical solver and the seed value, the numerical solution comprising joint parameters for the robotic arm to achieve the desired location of a tool center point of the robotic arm.

Another embodiment of the present disclosure provides a method of reducing calculation time for inverse kinematics for a robotic arm. Design values for components of a robot type are received. An analytical solver is developed using the design values. An analytical solution of joint parameters for the robot type is generated to achieve a desired location of a tool center point of the robot type. As-manufactured values for the components of a robotic arm of the robot type are determined. The as-manufactured values and the analytical solution are provided to a numerical solver as input. A numerical solution comprising joint parameters for the robotic arm is generated to achieve a desired location of a tool center point.

Yet another embodiment of the present disclosure provides a method of reducing calculation time for inverse kinematics for a robotic arm. An analytical solution of joint parameters for a robot type is generated to achieve a desired location of a tool center point of the robot type using an analytical model formed using designed lengths of components of the robot type. As-manufactured values for the components of a robotic arm of the robot type are determined. The as-manufactured values and the analytical solution are provided to a numerical solver as input. A numerical solution comprising joint parameters for the robotic arm is generated to achieve a desired location of a tool center point. The robotic arm is moved according to the numerical solution to place the tool center point of the robotic arm in the desired location.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a robotic arm in a manufacturing environment in accordance with an illustrative embodiment;

FIG. 4 is a flowchart of a method of reducing calculation time for inverse kinematics for a robotic arm in accordance with an illustrative embodiment;

FIG. 5 is a flowchart of a method of reducing calculation time for inverse kinematics for a robotic arm in accordance with an illustrative embodiment;

FIG. 6 is a flowchart of a method of reducing calculation time for inverse kinematics for a robotic arm in accordance with an illustrative embodiment;

FIG. 7 is an illustration of an aircraft manufacturing and service method in a form of a block diagram in accordance with an illustrative embodiment; and

FIG. 8 is an illustration of an aircraft in the form of a block diagram in which an illustrative embodiment may be implemented.

### DETAILED DESCRIPTION

The illustrative examples recognize and take into account that in robotics, inverse kinematics is the process of calculating the angles of joints needed to reach a desired tip location. A robotic arm has as-manufactured or “real” parameters as well as variables of the robot including angles and joint lengths.

The illustrative examples provide a solver that produces calibrated inverse kinematics solutions faster than a traditional numerical-only solver while giving the complete solution set of an analytical solver. The provided illustrative methods decrease calibrated inverse kinematics computation time. Implementation of the algorithm in the illustrative examples allows precise robotic movement calculations without large motion planning computation times for scenarios such as offline planning where many thousands of such computations need to be performed.

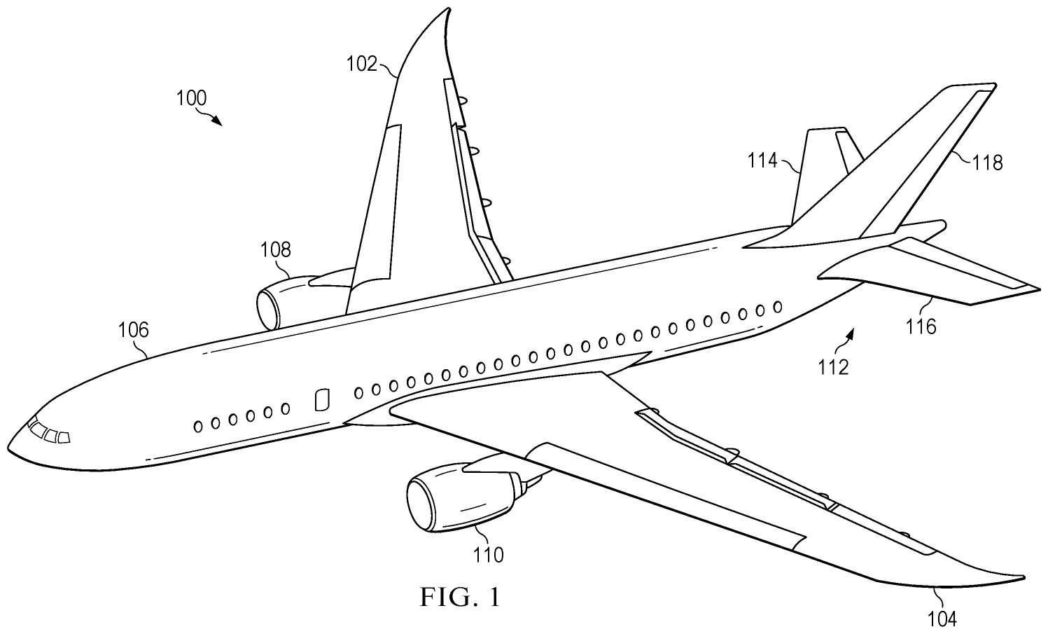

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have components manufactured using robots controlled using inverse kinematics determined using the methods of the illustrative examples. The inverse kinematics of the illustrative examples can be used to perform manufacturing operations on aircraft 100.

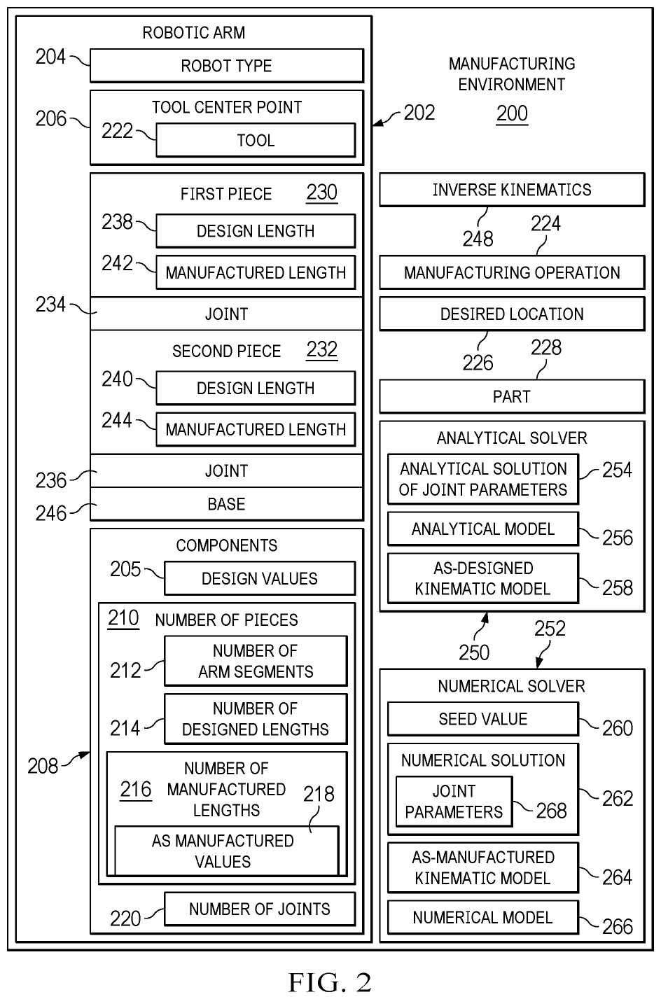

Turning now to FIG. 2, an illustration of a block diagram of a manufacturing environment is depicted in accordance with an illustrative embodiment. Manufacturing environment 200 has robotic arm 202. Robotic arm 202 is of robot type 204. Robot type 204 is a design for a robot. Robot type 204 has design values 205 for components 208. Robot arm 202 is a specific instance of robot type 204.

Robotic arm 202 has tool center point 206. Tool center point 206 is a location of robotic arm 202 to perform manufacturing operations. Tool center point 206 may be referred to as an operative location. To perform manufacturing operations using robotic arm 202, tool center point 206 needs to be located at desired location 226 in manufacturing environment 200.

Robotic arm 202 is formed by components 208. Components 208 of robotic arm 202 include number of pieces 210 connected by number of joints 220. In some illustrative examples, number of pieces 210 can be referred to as number of arm segments 212. Number of pieces 210 have number of designed lengths 214. Number of designed lengths 214 are the same as design values 205 of robot type 204. Number of pieces 210 have number of manufactured lengths 216.

As manufactured values 218 of robotic arm 202 comprise number of manufactured lengths 216. As manufactured values 218 can also include angles of robotic arm 202. In some illustrative examples, as manufactured values 218 can be described using Denavit-Hartenberg parameters.

The differences between number of manufactured lengths 216 and number of designed lengths 214 occur due to manufacturing tolerances. Manufacturing variability results in differences between number of designed lengths 214 of components 208 and number of manufactured lengths 216 of components 208.

In this illustrative example, number of pieces 210 comprises first piece 230 and second piece 232. First piece 230 is joined to second piece 232 by joint 234. Second piece 232 is joined to base 246 by joint 236. Joint 234 takes the form of any desirable type of joint. In some illustrative examples, joint 234 can take the form of a linear joint, a rotational joint, or a spherical joint. Joint 236 takes the form of any desirable type of joint. In some illustrative examples, joint 236 can take the form of a linear joint, a rotational joint, or a spherical joint.

First piece 230 has design length 238. Design length 238 is one of number of designed lengths 214. First piece 230 has manufactured length 242. Manufactured length 242 is one of number of manufactured lengths 216. A difference between design length 238 and manufactured length 242 is a result of manufacturing variability. The difference between design length 238 and manufactured length 242 results in difficulties performing inverse kinematics 248 for robotic arm 202.

Second piece 232 has design length 240. Design length 240 is one of number of designed lengths 214. Second piece 232 has manufactured length 244. Manufactured length 244 is one of number of manufactured lengths 216. A difference between design length 240 and manufactured length 244 is a result of manufacturing variability. The difference between design length 240 and manufactured length 244 results in difficulties performing inverse kinematics 248 for robotic arm 202.

Robotic arm 202 can be used to perform manufacturing operations, such as manufacturing operation 224, on parts, such as part 228. Robotic arm 202 has tool 222 attached to first piece 230. Tool 222 is connected to robotic arm 202 to perform manufacturing operation 224. Tool 222 is configured to perform manufacturing operation 224. Tool center point 206 is an operating point created by tool 222. In some illustrative examples, tool 222 is a permanent part of robotic arm 202. In some illustrative examples, tool 222 is removable and replaceable with other tools. Changing tool 222 can also change the location of tool center point 206.

Analytical solver 250 and numerical solver 252 are used in sequence to reduce the time to perform inverse kinematics 248 for robotic arm 202. Analytical solver 250 and numerical solver 252 are used in sequence to reduce the time to determine joint parameters 268 for robotic arm 202. Analytical solver 250 is used to determine a seed value 260 to reduce the computational time for determining numerical solution 262 in numerical solver 252.

Analytical solver 250 can be used to form analytical solution of joint parameters 254. Analytical solver 250 performs inverse kinematics 248 for robotic arm 202 in a set amount of time. Analytical solver 250 generates analytical solution of joint parameters 254 for robotic arm 202 in a set amount of time. The fixed computation time of analytical model 256 can be advantageous. However, analytical solution of joint parameters 254 has an undesirable level of precision. Analytical solver 250 is a deterministic formula or algorithm. In some illustrative examples, analytical solver 250 comprises an algorithm that utilizes as-designed kinematic model 258 to generate a kinematic result.

Numerical solver 252 is more precise than analytical solver 250. However, numerical solver 252 is significantly slower than analytical solver 250. Numerical solver 252 comprises an algorithm utilizing numerical model 266. Numerical model 266 is as-manufactured kinematic model 264 that generates a kinematic result.

To determine joint parameters for robotic arm 202 according to the illustrative examples, analytical solver 250 determines analytical solution of joint parameters 254 using design values 205 of robot type 204. Analytical solution of joint parameters 254 can achieve desired location 226 of tool center point 206 of robot type 204. Desired location 226 may also be referred to as a target coordinate. The target coordinate is typically specified in a global coordinate system. Coordinates can be converted from the global coordinate system to joint coordinates during inverse kinematics 248.

Analytical solution of joint parameters 254 is provided as seed value 260 to numerical solver 252. Numerical solution 262 is determined using numerical solver 252 and seed value 260. Numerical solution 262 comprises joint parameters 268 for robotic arm 202 to achieve desired location 226 of tool center point 206 of robotic arm 202.

Numerical solver 252 comprises an algorithm utilizing as-manufactured kinematic model 264. As-manufactured kinematic model 264 is created using as manufactured values 218. Analytical solution of joint parameters 254 provides seed value 260 that reduces calculation time of numerical solver 252. Seed value 260 allows for determination of numerical solution 262 in a desired amount of time.

After determining numerical solution 262, robotic arm 202 is moved according to numerical solution 262 to place tool center point 206 of robotic arm 202 in desired location 226. Manufacturing operation 224 is then performed using tool 222 at tool center point 206 of robotic arm 202 after moving robotic arm 202 according to numerical solution 262.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, number of pieces 210 can include more than two pieces. In some illustrative examples, number of pieces 210 comprises three arm segments. In other illustrative examples, joint parameters 268 can be determined using analytical solver 250 and numerical solver 252 for a different robot type other than a robotic arm.

Additionally, although analytical solver 250 is described as generating analytical solution of joint parameters 254, analytical solver 250 can generate multiple analytical solutions. In these illustrative examples, the multiple analytical solutions are provided to numerical solver 252 as seeds for numerical solver 252.

Analytical solver 250 produces all possible solutions. In this example, all possible solutions are all different configurations for robotic arm 202 that can achieve positioning tool center point 206 at desired location 226. In contrast, numerical solver 252 produces one or fewer solutions each time numerical solver 252 is run.

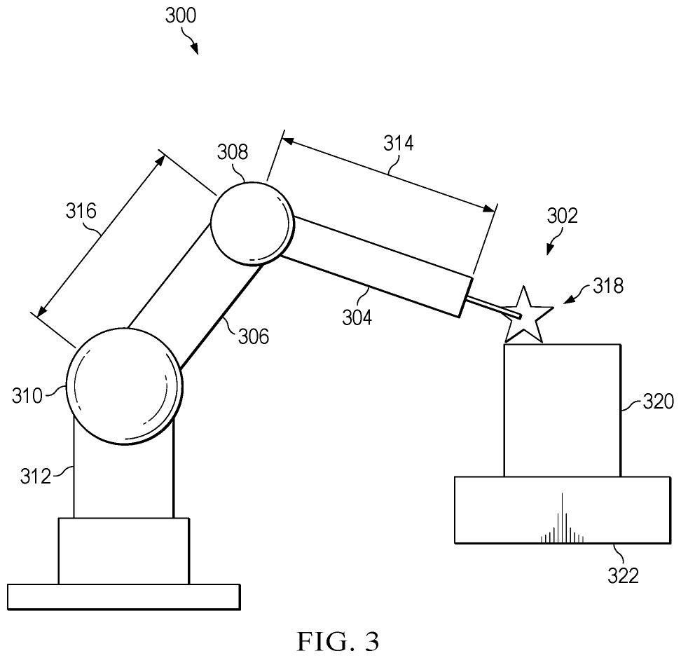

Turning now to FIG. 3, an illustration of a robotic arm in a manufacturing environment is depicted in accordance with an illustrative embodiment. Robotic arm 300 is a physical implementation of robotic arm 202 of FIG. 2.

Robotic arm 300 comprises tool center point 302. To perform a manufacturing operation on part 320 using tool 318, tool center point 302 is moved to a desired location using inverse kinematics. In some illustrative examples, desired location can be referred to as a target coordinate. To determine the joint parameters for robotic arm 300 using inverse kinematics, the design values and as-manufactured values for components of robotic arm 300 are determined and used.

Robotic arm 300 comprises first piece 304 and second piece 306. First piece 304 and second piece 306 are arm segments of robotic arm 300. First piece 304 is joined to second piece 306 by joint 308. Second piece 306 is joined to base 312 by joint 310.

Robotic arm 300 is a specific instance of a robot type. Although a robot type has design values for arm segment lengths, variation occurs during manufacturing. As a result of manufacturing variations, first piece 304 of robotic arm 300 has as-manufactured length 314. As a result of manufacturing variations, second piece 306 of robotic arm 300 has as-manufactured length 316.

To reduce inverse kinematics calculations for robotic arm 300, an analytic solution using as-designed lengths for first piece 304 and second piece 306 can be provided to a numerical solver. The numerical solver uses as-manufactured length 314, as-manufactured length 316, and the analytic solution to determine a numerical solution at a greatly reduced time.

After determining the numerical solution using the numerical solver, the numerical solution is used to move robotic arm 300 to place tool center point 302 at a desired location. After moving robotic arm 300, a manufacturing operation is performed on part 320 using tool 318. In this illustrative example, part 320 rests on support 322. However, in other illustrative examples, a manufacturing operation can be performed on a large structure, such as aircraft 100 of FIG. 1.

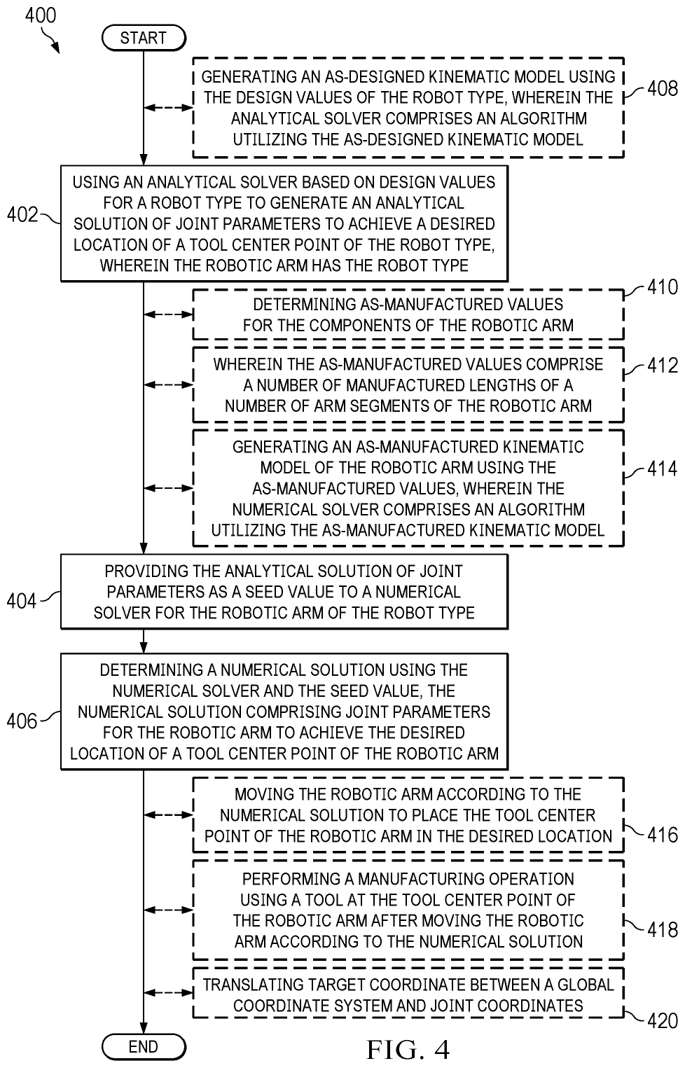

Turning now to FIG. 4, a flowchart of a method of reducing calculation time for inverse kinematics for a robotic arm is depicted in accordance with an illustrative embodiment. Method 400 can be performed to determine joint parameters for a robotic arm to perform manufacturing operations on a portion of aircraft 100 of FIG. 1. Method 400 can be performed using analytical solver 250 and numerical solver 252 of FIG. 2. Method 400 can be performed to determine joint parameters using inverse kinematics for robotic arm 300 of FIG. 3.

Method 400 uses an analytical solver based on design values for a robot type to generate an analytical solution of joint parameters to achieve a desired location of a tool center point of the robot type, wherein the robotic arm has the robot type (operation 402). The desired location may be referred to as a target coordinate. Method 400 provides the analytical solution of joint parameters as a seed value to a numerical solver for the robotic arm of the robot type (operation 404). Method 400 determines a numerical solution using the numerical solver and the seed value, the numerical solution comprising joint parameters for the robotic arm to achieve the desired location of a tool center point of the robotic arm (operation 406). Afterwards, method 400 terminates.

The analytical model is based on the design values for the robot type. In some illustrative examples, method 400 generates an as-designed kinematic model using the design values of the robot type, wherein the analytical solver comprises an algorithm utilizing the as-designed kinematic model (operation 408).

In some illustrative examples, method 400 determines as-manufactured values for the components of the robotic arm (operation 410). In some illustrative examples, the as-manufactured values comprise a number of manufactured lengths of a number of arm segments of the robotic arm (operation 412). In some illustrative examples, method 400 generates an as-manufactured kinematic model of the robotic arm using the as-manufactured values, wherein the numerical solver comprises an algorithm utilizing the as-manufactured kinematic model (operation 414).

In some illustrative examples, method 400 moves the robotic arm according to the numerical solution to place the tool center point of the robotic arm in the desired location (operation 416). In some illustrative examples, method 400 performs a manufacturing operation using a tool at the tool center point of the robotic arm after moving the robotic arm according to the numerical solution (operation 418). In some illustrative examples, method 400 translates the target coordinate between a global coordinate system and joint coordinates (operation 420).

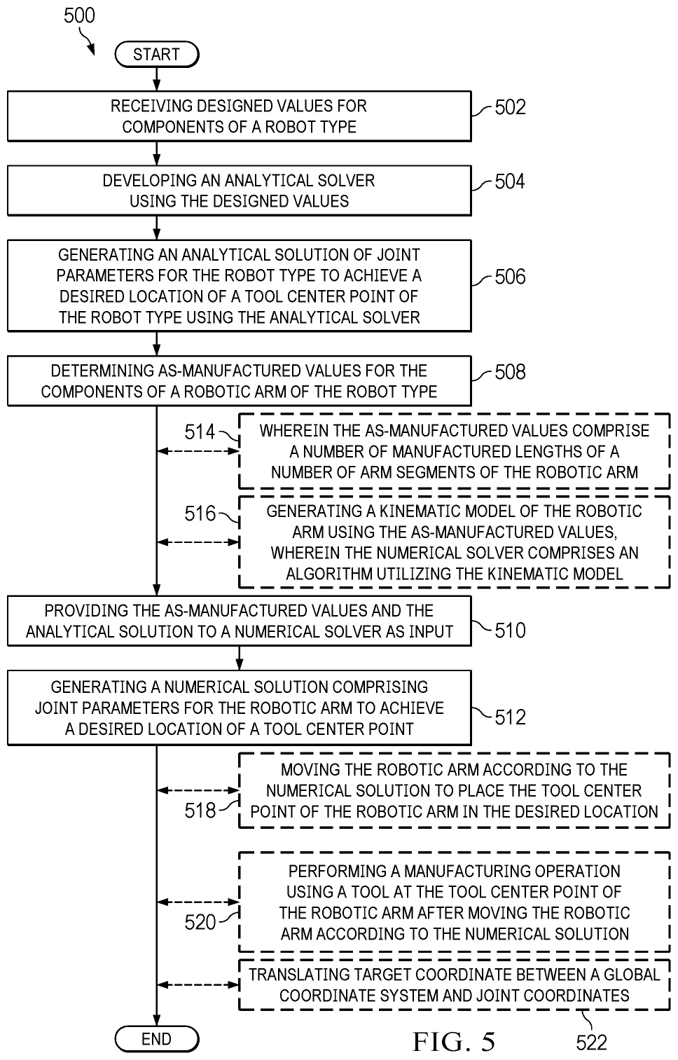

Turning now to FIG. 5, a flowchart of a method of reducing calculation time for inverse kinematics for a robotic arm is depicted in accordance with an illustrative embodiment. Method 500 can be performed to determine joint parameters for a robotic arm to perform manufacturing operations on a portion of aircraft 100 of FIG. 1. Method 500 can be performed using analytical solver 250 and numerical solver 252 of FIG. 2. Method 500 can be performed to determine joint parameters using inverse kinematics for robotic arm 300 of FIG. 3.

Method 500 receives design values for components of a robot type (operation 502). Method 500 develops an analytical solver using the design values (operation 504). Method 500 generates an analytical solution of joint parameters for the robot type to achieve a desired location of a tool center point of the robot type using the analytical solver (operation 506). Method 500 determines as-manufactured values for the components of a robotic arm of the robot type (operation 508). Method 500 provides the as-manufactured values and the analytical solution to a numerical solver as input (operation 510). Method 500 generates a numerical solution comprising joint parameters for the robotic arm to achieve a desired location of a tool center point (operation 512). Afterwards, method 500 terminates.

In some illustrative examples, the as-manufactured values comprise a number of manufactured lengths of a number of arm segments of the robotic arm (operation 514). In other illustrative examples, if the robot is a type of robot other than a robotic arm, the number of manufactured lengths can be of components other than arm segments. In some illustrative examples, method 500 generates a kinematic model of the robotic arm using the as-manufactured values, wherein the numerical solver comprises an algorithm utilizing the kinematic model (operation 516).

In some illustrative examples, method 500 moves the robotic arm according to the numerical solution to place the tool center point of the robotic arm in the desired location (operation 518). In some illustrative examples, method 500 performs a manufacturing operation using a tool at the tool center point of the robotic arm after moving the robotic arm according to the numerical solution (operation 520). In some illustrative examples, method 500 translates target coordinate between a global coordinate system and joint coordinates (operation 522).

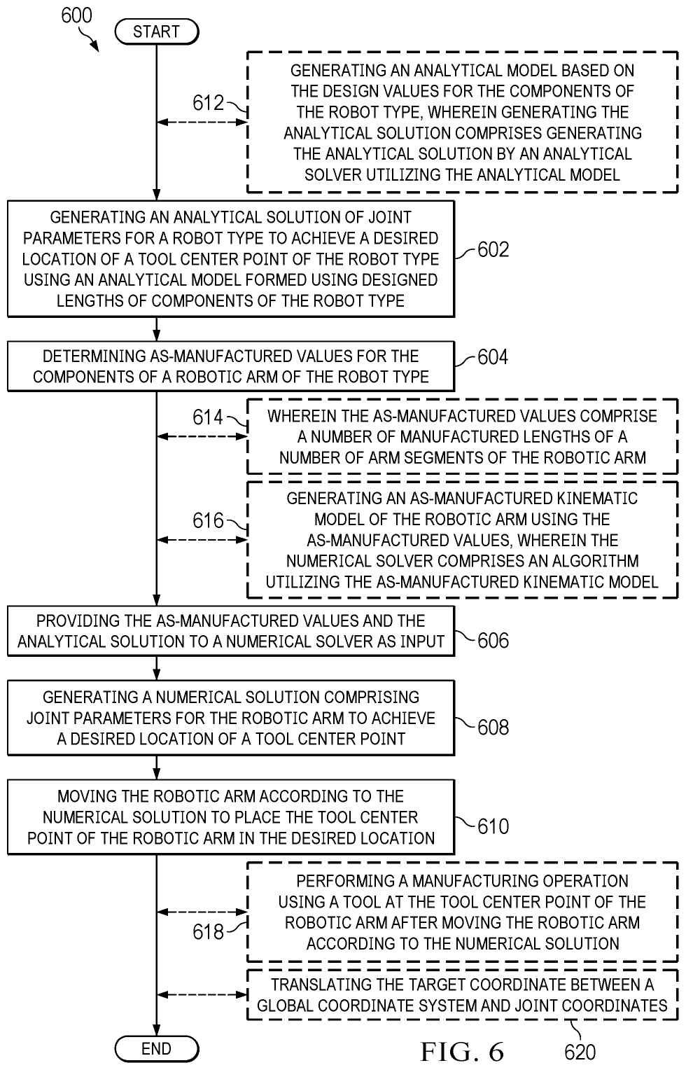

Turning now to FIG. 6, a flowchart of a method of reducing calculation time for inverse kinematics for a robotic arm is depicted in accordance with an illustrative embodiment. Method 600 can be performed to determine joint parameters for a robotic arm to perform manufacturing operations on a portion of aircraft 100 of FIG. 1. Method 600 can be performed using analytical solver 250 and numerical solver 252 of FIG. 2. Method 600 can be performed to determine joint parameters using inverse kinematics for robotic arm 300 of FIG. 3.

Method 600 generates an analytical solution of joint parameters for a robot type to achieve a desired location of a tool center point of the robot type using an analytical model formed using designed lengths of components of the robot type (operation 602). Method 600 determines as-manufactured values for the components of a robotic arm of the robot type (operation 604). Method 600 provides the as-manufactured values and the analytical solution to a numerical solver as input (operation 606). Method 600 generates a numerical solution comprising joint parameters for the robotic arm to achieve a desired location of a tool center point (operation 608). Method 600 moves the robotic arm according to the numerical solution to place the tool center point of the robotic arm in the desired location (operation 610). Afterwards, method 600 terminates.

In some illustrative examples, method 600 generates an analytical model based on the design values for the components of the robot type, wherein generating the analytical solution comprises generating the analytical solution by an analytical solver utilizing the analytical model (operation 612). In some illustrative examples, the as-manufactured values comprise a number of manufactured lengths of a number of arm segments of the robotic arm (operation 614). In some illustrative examples, method 600 generates an as-manufactured kinematic model of the robotic arm using the as-manufactured values, wherein the numerical solver comprises an algorithm utilizing the as-manufactured kinematic model (operation 616).

In some illustrative examples, method 600 performs a manufacturing operation using a tool at the tool center point of the robotic arm after moving the robotic arm according to the numerical solution (operation 618). In some illustrative examples, method 600 translates the target coordinate between a global coordinate system and joint coordinates (operation 620).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C, or item B and item C. Of course, any combination of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 408 through operation 420 may be optional. For example, operation 514 through operation 522 may be optional. As another example, operation 612 through operation 620 may be optional.

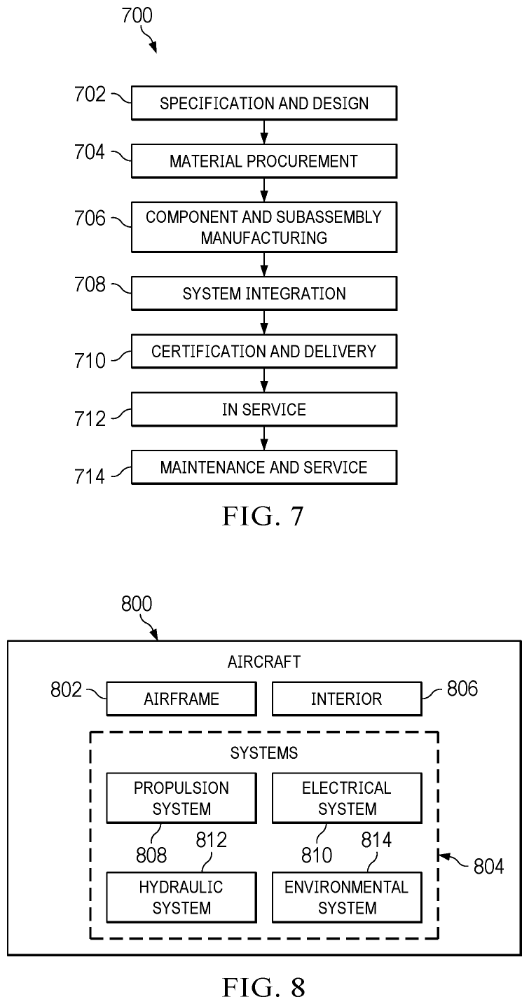

Illustrative embodiments of the present disclosure may be described in the context of aircraft manufacturing and service method 700 as shown in FIG. 7 and aircraft 800 as shown in FIG. 8. Turning first to FIG. 7, an illustration of an aircraft manufacturing and service method in the form of a block diagram is depicted in accordance with an illustrative embodiment. During pre-production, aircraft manufacturing and service method 700 may include specification and design 702 of aircraft 800 in FIG. 8 and material procurement 704.

During production, component and subassembly manufacturing 706 and system integration 708 of aircraft 800 takes place. Thereafter, aircraft 800 may go through certification and delivery 710 in order to be placed in service 712. While in service 712 by a customer, aircraft 800 is scheduled for routine maintenance and service 714, which may include modification, reconfiguration, refurbishment, or other maintenance and service.

Each of the processes of aircraft manufacturing and service method 700 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 8, an illustration of an aircraft in the form of a block diagram is depicted in which an illustrative embodiment may be implemented. In this example, aircraft 800 is produced by aircraft manufacturing and service method 700 of FIG. 7 and may include airframe 802 with plurality of systems 804 and interior 806. Examples of systems 804 include one or more of propulsion system 808, electrical system 810, hydraulic system 812, and environmental system 814. Any number of other systems may be included.

Apparatuses and methods embodied herein may be employed during at least one of the stages of aircraft manufacturing and service method 700. One or more illustrative embodiments may be manufactured or used during at least one of component and subassembly manufacturing 706, system integration 708, in service 712, or maintenance and service 714 of FIG. 7.

The illustrative examples decrease calibrated inverse kinematics computation time. Implementation of the illustrative examples allows precise robotic movement calculations without large motion planning computation times for scenarios such as offline planning where many thousands of such computations need to be performed.

The illustrative examples a hybrid of analytical and numerical solvers instead of either analytical or numerical solvers. The illustrative examples are faster than a numerical solver, uses calibrated kinematics, and provides all possible solutions (allows motion planners to optimize for different criteria, singularity, velocity). The illustrative examples command the robot according to an iterative approach to refine end point location until desired accuracy is reached.

The result is a solver that produces calibrated inverse kinematics solutions faster than a traditional numerical-only solver whilst giving the complete solution set of an analytical solver. The illustrative examples decrease calibrated inverse kinematics computation time. Implementation of this algorithm allows precise robotic movement calculations without large motion planning computation times for scenarios such as offline planning where many thousands of such computations need to be performed.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of reducing calculation time for inverse kinematics for a robotic arm comprising:
using an analytical solver based on design values of a robot type to generate an analytical solution of joint parameters to achieve a desired location of a tool center point of the robot type, wherein the robotic arm has the robot type;
providing the analytical solution of joint parameters as a seed value to a numerical solver for the robotic arm of the robot type; and
determining a numerical solution using the numerical solver and the seed value, the numerical solution comprising joint parameters for the robotic arm to achieve the desired location of a tool center point of the robotic arm.

2. The method of claim 1 further comprising:
determining as-manufactured values for components of the robotic arm.

3. The method of claim 2, wherein the as-manufactured values comprise a number of manufactured lengths of a number of arm segments of the robotic arm.

4. The method of claim 2 further comprising:
generating an as-manufactured kinematic model of the robotic arm using the as-manufactured values, wherein the numerical solver comprises an algorithm utilizing the as-manufactured kinematic model.

5. The method of claim 1 further comprising:
moving the robotic arm according to the numerical solution to place the tool center point of the robotic arm in the desired location.

6. The method of claim 5 further comprising:
performing a manufacturing operation using a tool at the tool center point of the robotic arm after moving the robotic arm according to the numerical solution.

7. The method of claim 1 further comprising:
generating an as-designed kinematic model using the design values of the robot type, wherein the analytical solver comprises an algorithm utilizing the as-designed kinematic model.

8. The method of claim 1, wherein determining the numerical solution comprises: translating the target coordinate between a global coordinate system and joint coordinates.

9. A method of reducing calculation time for inverse kinematics for a robotic arm comprising:
receiving design values for components of a robot type;
developing an analytical solver using the design values;
generating an analytical solution of joint parameters for the robot type to achieve a desired location of a tool center point of the robot type using the analytical solver;
determining as-manufactured values for the components of a robotic arm of the robot type;
providing the as-manufactured values and the analytical solution to a numerical solver as input; and
generating a numerical solution comprising joint parameters for the robotic arm to achieve a desired location of a tool center point.

10. The method of claim 9 further comprising:
moving the robotic arm according to the numerical solution to place the tool center point of the robotic arm in the desired location.

11. The method of claim 10 further comprising:
performing a manufacturing operation using a tool at the tool center point of the robotic arm after moving the robotic arm according to the numerical solution.

12. The method of claim 9, wherein the as-manufactured values comprise a number of manufactured lengths of a number of arm segments of the robotic arm.

13. The method of claim 9, wherein determining the numerical solution comprises translating the target coordinate between a global coordinate system and joint coordinates.

14. The method of claim 9 further comprising:
generating a kinematic model of the robotic arm using the as-manufactured values, wherein the numerical solver comprises an algorithm utilizing the kinematic model.

15. A method of reducing calculation time for inverse kinematics for a robotic arm comprising:
generating an analytical solution of joint parameters for a robot type to achieve a desired location of a tool center point of the robot type using an analytical model formed using designed lengths of components of the robot type;
determining as-manufactured values for the components of a robotic arm of the robot type;
providing the as-manufactured values and the analytical solution to a numerical solver as input;
generating a numerical solution comprising joint parameters for the robotic arm to achieve a desired location of a tool center point using the numerical solver; and
moving the robotic arm according to the numerical solution to place the tool center point of the robotic arm in the desired location.

16. The method of claim 15 further comprising:
performing a manufacturing operation using a tool at the tool center point of the robotic arm after moving the robotic arm according to the numerical solution.

17. The method of claim 15, wherein the as-manufactured values comprise a number of manufactured lengths of a number of arm segments of the robotic arm.

18. The method of claim 15 further comprising:
generating an as-manufactured kinematic model of the robotic arm using the as-manufactured values, wherein the numerical solver comprises an algorithm utilizing the as-manufactured kinematic model.

19. The method of claim 15 further comprising:
generating an analytical model based on design values for the components of the robot type, wherein generating the analytical solution comprises generating the analytical solution by an analytical solver utilizing the analytical model.

20. The method of claim 15, wherein generating the numerical solution comprises translating the target coordinate between a global coordinate system and joint coordinates.
